(19) United States
(12) Patent Application Publication
(10) Pub. No.: US 2010/0112527 A1
(43) Pub. Date: May 6, 2010

(54) METHOD FOR FABRICATING AN IMPLANTED DENTAL RESTORATION

(76) Inventor: Timothy Dow Chapel, Jackson, MI (US)

Correspondence Address: Jerome R. Drouillard, 10213 Tims Lake Blvd., Grass Lake, MI, 49240, US

(21) Appl. No.: 12/467,484

(22) Filed: May 18, 2009

Related U.S. Application Data
(60) Provisional application No. 61/110,594, filed on Nov. 2, 2008.
(60) Provisional application No. 61/110,596, filed on Nov. 2, 2008.

(51) Int. Cl. A61C 5/10

(52) U.S. Cl. 433/223

(57) ABSTRACT

A method for fabricating an implant-based dental restoration includes attaching an abutment analog to a dental implant contained in a patient's mouth in an angularly indexed fashion. After an impression is made, an implant analog will be attached to the abutment analog, which is contained within the impression, and the assembled impression, including the abutment analog, including an impression coping and abutment base, will be employed along with the implant analog to make a model of a patient's mouth structure, including thread-timed implant analogs, to permit fabrication of an angle-corrected dental restoration device in a laboratory.

### CROSS REFERENCE TO RELATED APPLICATIONS

This application claims priority to Provisional Patent Applications No. 61/110,594 and 61/110,596 both filed Nov. 2, 2008, the entire disclosures of which are hereby incorporated by reference and relied upon.

### BACKGROUND OF THE INVENTION

1. Field of the Invention

The present invention relates to a method for constructing a dental restoration which is retained within the mouth of a patient through the use of implanted devices.

2. Related Art

The techniques and hardware used for implant dentistry continue to develop steadily. In general, the process of providing dentition based upon implants begins with a visit by a patient to a dentist or oral surgeon, who places one or more implants within the desired structure, such as a mandible. Once the implants have become integrated with the patient's bony matrix, the patient visits his or her dentist, wherein the process of constructing the restoration device begins.

Typically, a problem faced by dentists in executing an implant-based restoration arises from the fact that it is very difficult to assure that the central axes of each of the implants processed by the oral surgeon are in fact parallel to one another. This is important because implants have threaded cavities into which denture attaching abutments are placed, and if the lack of parallelism between abutments is extreme, it may be difficult, if not impossible, to insert a denture without considerable angular adjustments to the fastenings which are affixed to the screwed-in abutments. This lack of angularity requires dentists to cement angular adjusting devices to the abutments, while working inside the patient's mouth. This is undesirable because achieving the desired parallel orientation may be very time consuming, and also requires the handling of exceedingly small parts within the confines of the mouth.

Although it has been recognized for some time that it would be desirable to provide a way of processing the fabrication of a restorative device outside the patient's mouth, this has not generally been possible because the screw-mounted nature of the abutments used in such restorations allow, by their very nature, the abutments to turn to whatever rotational position in 360° they are placed. Although each abutment is limited to a single position in which it is thread locked against the insert into which the abutment is mounted, it has not been possible to precisely position implant analogs in a dental model which is poured up, typically of plaster in a laboratory, so as to allow the abutments and any hardware attached to them to be precisely oriented at the angle required to allow the denture to be fitted to the patient.

It would be desirable to provide a method by which hardware for mounting a denture, and specifically abutments for mounting a denture or other restoration device within a patient's mouth, may be precisely angularly oriented, while allowing accurate replication of the orientation within the patient's mouth in the laboratory, thereby permitting almost the entire fabrication process to occur in the more favorable laboratory environment, rather than to be more or less evenly divided between the first steps taken within the patient's mouth and steps taken in the laboratory.

### SUMMARY OF THE INVENTION

According to a first aspect of the present invention, a method for fabricating an implant-based dental restoration includes threadedly fixing an abutment analog into a dental implant contained in a patient's mouth, and taking an impression of the patient's mouth, including the abutment analog. The finished impression is then removed from the patient's mouth and the abutment analog is also removed from the patient's mouth. An implant analog is threadedly fixed to the abutment analog and the abutment analog is placed into a space defined by the abutment analog in the finished impression.

As used herein, the term “abutment analog” means an abutment base combined with an impression coping. This device is said to be an abutment “analog” because it substitutes, or is a surrogate, for the abutment actually used to attach a dental restoration device, such as a denture or bridge, to the patient's dental implants. Also, the term “implant analog” means a device which closely resembles an implant within a patient's mandible, for example, but is used within a model of the patient's oral structure to allow the dental lab to precisely construct the dental restoration device in the laboratory. The implant analog, when attached to the abutment analog, allows a model of the patient's lower jaw to be poured in plaster, for example, including the implant analog which simulates an implant device carried in the patient's mandible or other bony structure.

According to another aspect of the present invention, a method further includes tightening an abutment analog to a dental implant with a torque wrench, and tightening an implant analog to an abutment analog with a torque wrench. The use of a torque wrench to tighten the abutment analog to the dental implant and to tighten the implant analog to the abutment analog assures that the rotational or angular orientation of the implant analog matches the angular orientation of an implant actually carried within the patient's mouth.

According to another aspect of the present invention, the present method further includes fabricating a model of the patient's dental configuration from an impression, including the implant analog, and fabricating a dental restoration device using the fabricated model including the implant analog. Finally, the fabricated restorative dentition is affixed to the patient using at least one, or usually more, dental implants. These are the implants which participated in the impression-making part of the process.

According to another aspect of the present invention, a method for fabricating an implant-based dental restoration includes attaching an abutment analog to a dental implant contained in a patient's mouth, with the abutment analog being angularly indexed to the patient, and taking an impression of the patient's mouth, including the abutment analog. Then, the impression is removed from the patient's mouth and the abutment analog is also removed from the patient's mouth. The abutment analog is placed into a space defined by the abutment analog in the impression, with the implant analog first being attached to the abutment analog in an indexed angular position which is the same as the indexed position used for attaching the abutment analog to the implant.

According to another aspect of the present invention, a method for fabricating an implant-based dental restoration includes affixing an abutment analog including an abutment base and an impression coping which is attached and indexed to the abutment base, to a dental implant contained in a patient's mouth, with the abutment analog being angularly indexed to the implant. Then, an open tray impression is taken of the patient's mouth, including the abutment analog. The impression, including the impression coping portion of the abutment analog, is removed from the patient's mouth. Then, the abutment base is removed from the patient's mouth. An implant analog is then attached to the abutment base, in an indexed angular position which is the same as the indexed position used for attaching the base to the implant, and the abutment base and implant analog are reattached and reindexed to the impression coping

According to another aspect of the present invention, the abutment base bears a plurality of unique angular indexing indicia which are registrable with a set of unique angular indexing indicia borne by the impression coping.

It is an advantage of the present method that an implant based dental restoration device may be fabricated completely in a dental laboratory, without the need for a dentist and patient to engage in cementing or fastening of angled abutment bases while working within the patient's mouth.

It is another advantage of a method according to the present invention that chair time of both the dentist and the patient will be saved because of the absence of the need to assemble angular correction hardware within the patient's mouth.

It is yet another advantage of a method according to the present invention that cost is controlled because it is more efficient to utilize a laboratory build a dental restoration device in its entirety, rather than requiring a dentist to do a portion of the construction, which is then handed off to the laboratory, and subject to errors of measurement and angularity.

Other advantages, as well as features of the present invention, will become apparent to the reader of this specification.

### BRIEF DESCRIPTION OF THE DRAWINGS

FIG. 1 is a partially schematic representation of a dental restoration device which is implant based and which is mounted to the mandible of a patient.

FIG. 2 is an abutment analog for use with a closed tray impression.

FIG. 3 is similar to FIG. 2, but shows the abutment analog in an exploded view.

FIG. 4 is similar to FIGS. 2 and 3, but shows an abutment analog, and a dental model, in a partially sectional view.

FIG. 5 illustrates an assembled abutment analog for use with an open tray impression.

FIG. 6 shows the abutment analog of FIG. 5 in an exploded presentation.

FIG. 7 shows the abutment analog of FIGS. 5 and 6 in section.

FIG. 8 is a process flow diagram for using the closed tray abutment analog of FIGS. 2, 3 and 4.

FIG. 9 is a process flow diagram for use with the open tray abutment analog of FIGS. 5, 6 and 7.

### DETAILED DESCRIPTION OF THE PREFERRED EMBODIMENTS

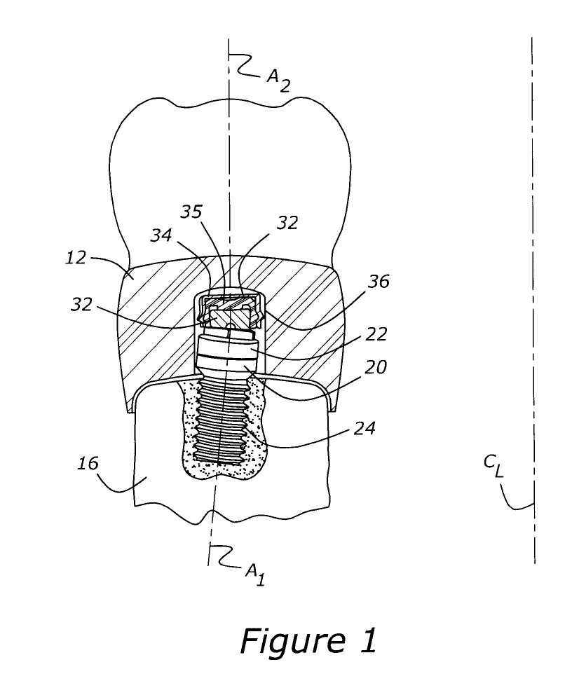

As shown in FIG. 1, an implant-based dental restoration includes an implant, 20, which is shown as having been placed within a patient's mandible, 16. As shown in FIG. 1, the center axis, A₁, of implant 20 is not parallel to the center line, or more precisely, the central plane, C_{L}, of the patient's mandible. In other words, implant 20 is at an angle to an imaginary central plane, C_{L}, extending through the patient's mouth. This lack of parallelism is not desirable, and is typically corrected through the use of hardware further described herein. The dental restoration also includes an abutment base, 22, which is threaded into internal threads, 24, carried within implant 20. Abutment base 22 provides a mounting location for a geometric compensator 32, which corrects for the angular mismatch between axis A₁ of implant 20 and center line or plane C_{L} of the patient's mouth. Geometric compensator 32 allows the axis, A₂, of a pressure sensitive fastening, 36, which is attached to geometric compensator 32, to be parallel with C_{L}, thereby assuring the ease of attaching of a dental restoration device, 12, including a prosthetic tooth, 18, to the patient.

Plastic insert 35 holds geometric compensator 32 within a cup-shaped retainer, 34, which is mounted permanently within dental restoration device 12. Because geometric compensator 32 is itself an angle correction device, it is critical that the rotational orientation of abutment base 22 be accurately maintained throughout the process of fabricating and fitting restoration device 12. This is accomplished by maintaining the thread timing of abutment base 22 according to the present invention. It will be appreciated that inadvertent rotation of abutment base 22 about its threaded axis would likely cause the angular correction otherwise produced by geometric compensator 32 to be lost, which would effectively destroy the function of compensator 32, while rendering fitting of the completed restoration device a very difficult proposition for both the dentist and the patient.

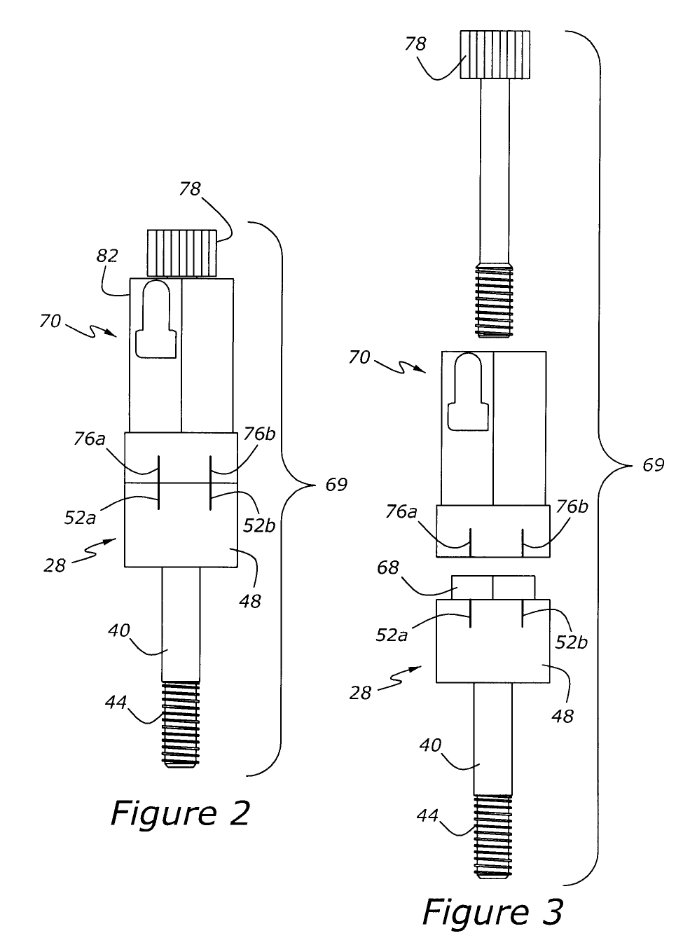

FIGS. 2, 3 and 4 show a closed tray abutment analog, 69, which includes an abutment base, 28, having an internal thread 50, which is engaged by a threaded fastener, 78. Fastener 78 passes through a bore, 74, formed in a closed tray impression coping, 70, for the purpose of attaching impression coping 70 to abutment base 28. Abutment base 28 has a shank, 40, with threads 44, which allow abutment base 28, and, therefore, abutment analog 69, to be threadedly fixed into a dental implant, 20, contained in a patient's mouth (FIG. 1). Because screw threads are used on shank 40, as well as within implant 20, the act of threadedly engaging abutment analog 69 with implant 20 will result in the abutment analog being angularly indexed to implant 20 once the threads are fully engaged and the head, 48, of abutment 28 is in contact with implant 20.

Impression coping 70 has a non-circular indentation, 82, which prevents impression coping 70 from rotating within the finished impression. Note that impression coping 70 also has a number of unique, color-coded, angular indexing indicia 76a and 76b, which are registrable with a similar set of unique, replicated, angular indexing indicia, 52a and 52b, which are borne upon head 48 of abutment base 28. Abutment base 28 has a male hexagonal antirotation feature, 68, formed at the uppermost portion of head 48, which engages a female hexagonal antirotation feature, 62, formed in impression coping 70, in much the same manner as a polygonal socket wrench engages a matching fastener head. Abutment analog 69 has an installed height which is less than the operational height of a closed impression tray, allowing an impression tray and impression to be removed from a patient's mouth without first disengaging either impression coping 70 or abutment base 28 from dental implant 20.

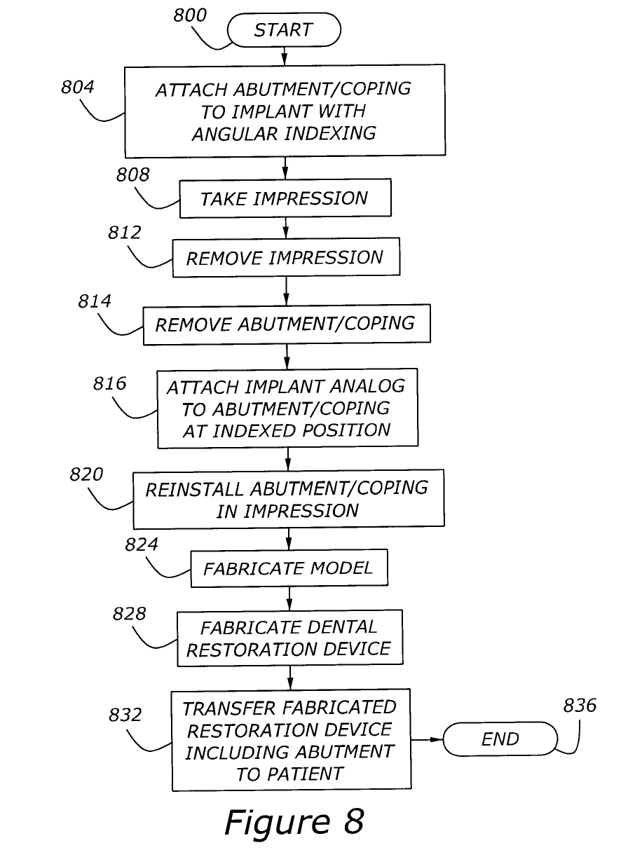

Abutment analog 69 is employed according to the method shown in FIG. 8, wherein prior to the start at block 800, the dentist or other operator attaches an abutment base, 28, to an impression coping 70, using fastener 78. Indices 52a and 52b are aligned with indices 76a and 76b, respectively, as part of this assembly step. Those skilled in the art will appreciate in view of this disclosure that abutment 28 may be an actual abutment employed later to attach the completed dental restoration device to the patient, or, alternatively, may be a surrogate for such a device, and used only for the purpose of processing and fabricating a dental restoration device.

After the abutment and impression coping are attached to one another, the assembled abutment analog 69 is attached to implant 20 with angular indexing at block 804. In a preferred embodiment, angular indexing is achieved at block 804 by torquing abutment analog 69 to implant 20 according to a predetermined torque value. This may be accomplished by applying a torque wrench to a polygonal upper portion of abutment analog 69. Then, the processor moves to block 808, where an impression is taken using conventional impression materials. Subsequently, at block 812, the impression is removed, leaving abutment analog 69, including the impression coping, affixed within the patient's mouth. After removing the impression, abutment 28 and impression coping 70 are removed at block 814, and an implant analog, 38, is threadedly attached to abutment base 28 at an indexed position which is the same indexed position at which abutment analog 69, including abutment base 28, was attached to implant 20. This is achievable by torquing implant analog 38 to abutment base 28 with the same torque value employed earlier to torque abutment base 28 to implant 20. These two uses of measured torque tightening assure that accurate thread timing is established for use in the laboratory to fabricate the patient's restoration device.

Those skilled in the art will appreciate in view of this disclosure that the present invention may be practiced without employing a torque wrench by using manually applied tightening torque to achieve a thread lock between abutment analog 69 and implant 20 in the first case, and between abutment analog 69 and implant analog 38 at a subsequent step of the present process. Relying upon the presence of a thread lock condition, which is manually discernable by a steep rise in tightening torque, although not as precise as using a torque wrench to achieve indexing in a repeatable manner, is believed to be an acceptable alternative in many cases.

At block 820, abutment analog 69 and implant analog 36 are installed in the impression in the precise orientation established during the impression making step. Torquing of implant analog 36 to abutment analog 69 prior to re-insertion of the abutment analog into the impression avoids subjecting the abutment analog to excessive torques which could cause undesirable rotational shifting of abutment analog 69 within the impression. As noted above, this assures that the thread timing of implant analog 38 replicates the thread timing of implant 20.

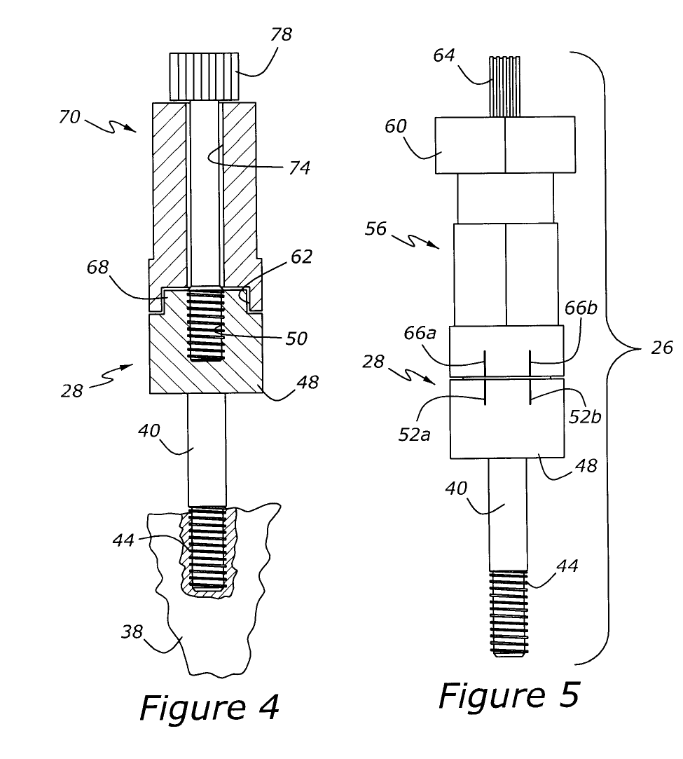

At block 824, a model of the patient's dentition or mouth is fabricated, for example, with plaster-of-paris (item 37 at FIG. 4), followed by fabrication of a dental restoration device at block 828. Because the present method allows the spatial location and thread timing of implants 20 to be accurately replicated by implant analogs 38 in the model made of the patient's mouth, the worker in a dental laboratory is able to accurately produce and implement all of the angularity changes required to construct a dental restoration device which is easily installed in the patient's mouth. In other words, the laboratory implements the angle corrections, described in connection with FIG. 1, which were formerly the responsibility of the dentist to both determine and partially implement, and which depended ultimately upon a less than satisfactory system for handing off angle corrections to the laboratory.

Once the fabrication is completed at block 828, the completed restoration device is transferred, including any abutments supplied by the laboratory, to the patient, and the method ends at block 836.

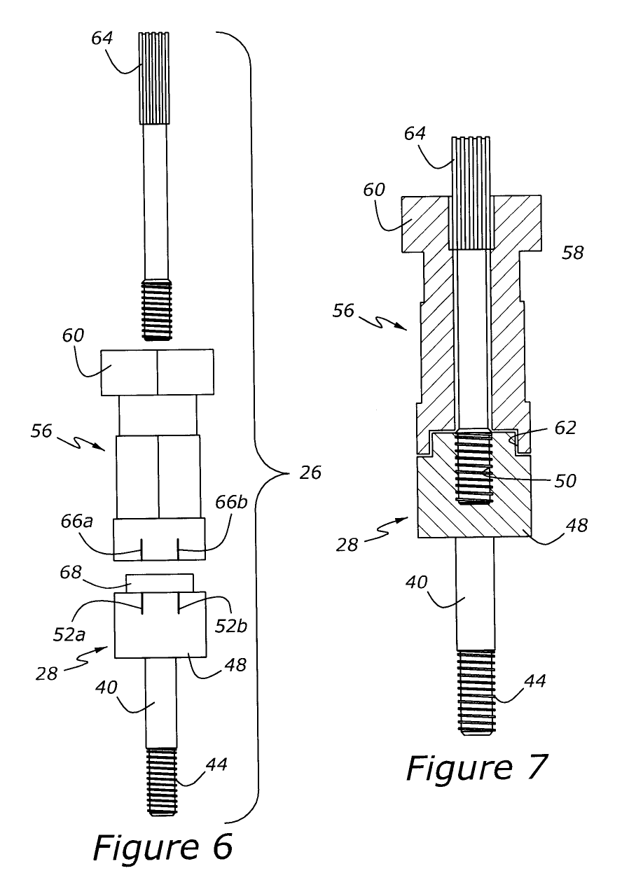

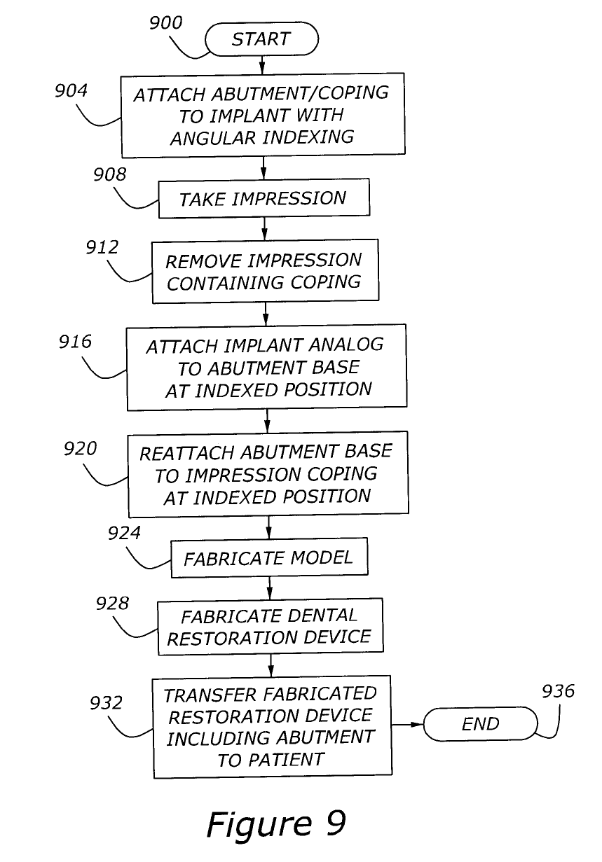

The method shown at FIG. 9, which applies to an open tray impression, is similar to the method disclosed in FIG. 8, except that following a start at block 900, and the attachment of the abutment coping to the implant with angular indexing at block 904 using either a torque wrench, or manual tightening until thread lock is sensed, and the impression taking at block 908, the impression removed at block 912 includes the open tray impression coping, 56, (FIGS. 5-7) which has a non-circular section, 60, formed therein to prevent unwanted rotation of impression coping 56 within the impression. This means that once the impression is taken, threaded fastener 64 will be removed, so as to allow the impression coping 56 to be separated from abutment base 28. In essence, abutment analog 26 has an installed height which is at least proximate the operational height of an open impression tray, so that an impression tray and impression bearing impression coping 56 may be removed from a patient's mouth after disengaging impression coping 56 from base 28. As an additional part of block 912, once the impression containing impression coping 56 has been removed from the patient's mouth, abutment base 28 will be removed from implant 20 and implant analog 36 will be torqued to abutment base 28 at block 916. This assures that implant analog 36 has been attached at the correctly indexed position. Then, at block 920, abutment base 28, bearing implant analog 36, will be reattached to impression coping 56, using indices 52a, and 52b indexed with indices 66a and 66b, to re-establish the indexed position which was used to make the impression. As before, a model will be fabricated at block 924 followed by fabrication of the dental restoration device at block 928 and transfer of the fabricated restoration device, including appropriate abutments, at block 932, followed by the end of the process at block 936. The abutments 28 used in the final steps of the restoration could be the original ones used in making the impression, or yet other abutments which provide necessary fastening features for the dental restoration device.

The foregoing invention has been described in accordance with the relevant legal standards, thus the description is exemplary rather than limiting in nature. Variations and modifications to the disclosed embodiment may become apparent to those skilled in the art and fall within the scope of the invention. Accordingly the scope of legal protection afforded this invention can only be determined by studying the following claims.

What is claimed is:

1. A method for fabricating an implant-based dental restoration, comprising:
threadedly fixing an abutment analog into a dental implant contained in a patient's mouth;
taking an impression of the patient's mouth, including the abutment analog;
removing the finished impression from the patient's mouth;
removing said abutment analog from the patient's mouth;
threadedly fixing an implant analog to said abutment analog; and
placing said abutment analog into a space defined by the abutment analog in the finished impression, with said abutment analog being placed into the impression in the same orientation which it occupied when the impression was in the patient's mouth.

2. A method according to claim 1, further comprising tightening said abutment analog to said dental implant with a torque wrench and tightening said implant analog to said abutment analog with a torque wrench.

3. A method according to claim 1, further comprising tightening said abutment analog to said dental implant until thread lock is achieved and tightening said implant analog to said abutment analog until thread lock is achieved.

4. A method according to claim 1, further comprising:
fabricating a model of the patient's dental configuration, including said implant analog, from said impression;
fabricating a dental restoration device, using the fabricated model including said implant analog; and
fixing the fabricated restorative dentition to the patient, using said dental implant.

5. A method according to claim 1, wherein said abutment analog comprises a base which is attached to said dental implant and an impression coping which is indexed with, and attached to, said base.

6. A method for fabricating an implant-based dental restoration, comprising:
attaching an abutment analog to a dental implant contained in a patient's mouth, with the abutment analog being angularly indexed to the implant;
taking an impression of the patient's mouth, including the abutment analog;
removing the impression from the patient's mouth;
removing said abutment analog from the patient's mouth;
replacing said abutment analog within the impression according to the orientation defined by the abutment analog in the impression; and
attaching an implant analog to said abutment analog, in an indexed angular position which is the same as the indexed position used for attaching the abutment analog to the implant.

7. A method according to claim 6, further comprising:
fabricating a model of the patient's dental configuration, including said implant analog, from said impression;
fabricating a dental restoration device, using the fabricated model including said implant analog; and
fixing the fabricated restorative dentition to the patient, using said dental implant.

8. A method according to claim 6, wherein said abutment analog is angularly indexed to said dental implant by threadedly engaging and torquing the abutment analog into an internally threaded portion of the dental implant.

9. A method according to claim 6, wherein said abutment analog comprises a base which is attached to said dental implant and an impression coping which is indexed with, and attached to, said base.

10. A method according to claim 6, further comprising assembling said abutment analog by indexing an impression coping with an abutment base and by retaining the impression coping to the base with a threaded fastener.

11. A method according to claim 6, wherein said abutment analog is angularly indexed to said dental implant by threadedly engaging and thread locking the abutment analog into an internally threaded portion of the dental implant.

12. A method for fabricating an implanted dental restoration, comprising:
fixing at least one abutment analog to a dental implant contained in a patient's mouth;
taking an impression of the patient's mouth, including the abutment analog;
removing the impression from the patient's mouth;
removing said at least one abutment analog from the patient's mouth;
placing said at least one abutment analog into a space defined by the abutment analog in the impression; and
attaching an implant analog to said abutment analog.

13. A method for fabricating an implant-based dental restoration, comprising:
affixing an abutment analog, comprising an abutment base and an impression coping which is attached and indexed to the abutment base, to a dental implant contained in a patient's mouth, with the abutment analog being angularly indexed to the implant;
taking an open tray impression of the patient's mouth, including the abutment analog;
removing the impression, including the impression coping portion of the abutment analog, from the patient's mouth;
removing said abutment base from the patient's mouth;
attaching an implant analog to said abutment base, in an indexed angular position which is the same as the indexed position used for attaching the base to the implant;
re-attaching and re-indexing the abutment base and attached implant analog to the impression coping contained within the impression, while maintaining the orientation defined by the abutment analog in the impression.

14. A method for fabricating an implant-based dental restoration according to claim 13, wherein said impression coping is attached to said abutment base with a threaded fastener.

15. A method for fabricating an implant-based dental restoration according to claim 13, wherein said abutment base is threadedly affixed to said dental implant.

16. A method for fabricating an implant-based dental restoration according to claim 13, wherein said abutment base bears a plurality of unique angular indexing indicia which are registrable with a set of unique angular indexing indicia borne by said impression coping.

17. A method according to claim 13, further comprising:
fabricating a model of the patient's dental configuration, including said implant analog, from said impression;
fabricating a dental restoration device, using the fabricated model including said implant analog; and
fixing the fabricated restorative dentition to the patient, using said dental implant.
